(19) United States
(12) Patent Application Publication
(10) Pub. No.: US 2009/0130623 A1
(43) Pub. Date: May 21, 2009

(54) METHOD AND APPARATUS FOR EFFECTING DENTAL MEASUREMENTS USING A BODY-CONTACTING ELECTRODE

(75) Inventors: Ilan CROHN, Nahariyha (IL); Jacob Levy, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: TECHDENT TECHNOLOGIES LTD., Nahariya (IL)

(21) Appl. No.: 12/274,369

(22) Filed: Nov. 20, 2008

Related U.S. Application Data
(60) Provisional application No. 60/989,133, filed on Nov. 20, 2007.

(51) Int. Cl. A61C 3/00; A61C 5/02

(52) U.S. Cl. 433/32; 433/102; 433/224

(57) ABSTRACT

Some embodiments of the present invention provide an apparatus comprising: a) a root canal electrode insertable into the root canal of a tooth of a patient; b) a control unit including: i) a housing; ii) a current generator having a first terminal and a second terminal, the current generator being operative to produce a time varying current having a frequency of at least about 50 KHz and at most about 300 KHz between the first and second terminals, the current generator being deployed within the housing of the control unit; and iii) a detection element configured to sense an impedance-related parameter between the first and second terminals of the current generator, the detection element being deployed within the housing of the control unit; and c) an electrode patch detachably attached to the control unit, the electrode patch having a body-contactable surface that: i) is skin adhesive and ii) includes an electrically conductive region, the electrically-conductive region being in electrical contact with the first terminal of the current generator; and d) a wire (for example, an insulated wire that is at least 10 cm or at least 20 cm long) connecting the root canal electrode to the control unit such that the root canal electrode is in electrical contact with the second terminal of the current generator.

### CROSS-REFERENCE TO RELATED APPLICATIONS

This patent application claims the benefit of U.S. Provisional Patent Application No. 60/989,133 filed Nov. 20, 2007 by the present inventors.

### FIELD OF THE INVENTION

The present invention relates to dental treatment, and in particular to methods and apparatus for detecting an apical position in a root canal of a tooth.

### BACKGROUND AND RELATED ART

The invention is related to endodontics, which is the field in dentistry devoted to treatment of teeth root canals. During such treatment the endodontist or dentist or other practitioner has to clean the root canal and remove rotten and infected tissue from the canal to enable access with drugs and sealing materials. The opening and cleaning of the canal is performed by means of dental files that are gradually inserted into the root canal in a rotational motion. One of the main concerns of the endodontist is to reach accurately the apical constriction or eventually the apical foramen (apex). The length of insertion of the file into the canal is known as working length.

Modern endodontics applies electronic apex locators, measuring the apical distance, i.e. the distance of the file tip from the apical foramen and the apical constriction. Usually the electronic apex locator drives an electric signal through two electrodes—(i) a first “measurement electrode” (for example, the dental file itself or a combination of the dental file and another element connected to the dental file—for example, a so-called “file clip”) at least a portion of which is inserted at least partially into the root canal and (ii) a second “lip electrode” contacting the patient's lip. This second electrode is usually a metal hook, hanging on the patient's lower lip.

The apex locators function is based on the behavior of the living tissue between both electrodes, which is equivalent to a capacitor parallel to a resistor. It is well known that when approaching to the apical area, the value of the resistive part decreases and the capacitance increases. The capacitance increases significantly in the vicinity of the apical range. The design of modern electronic apex locators is mostly based on these features. Most commercially-available apex locators use “low frequency” measuring signals having a frequency between 400 Hz and 10,000 HZ.

Below is a listing of patents, published patent applications, and non-patent publications that provide potentially relevant related art. Each patent, published patent application, and non-patent publication is incorporated herein by reference in its entirety. WO2007/0578781; U.S. Pat. No. 4,272,531; U.S. Pat. No. 3,993,044; U.S. Pat. No. 4,447,206; U.S. Pat. No. 4,243,388; U.S. Pat. No. 3,901,216; U.S. Pat. No. 3,753,434; U.S. Pat. No. 5,096,419; U.S. Pat. No. 5,112,224; U.S. Pat. No. 5,211,556; U.S. Pat. No. 5,295,833 and U.S. Pat. No. 6,221,031.

### SUMMARY OF EMBODIMENTS

The present inventor is now disclosing that instead of using a “lip electrode” as the second electrode it is possible to provide employ an “extra-oral electrode” for example, connected to the patient's skin by a wrist, conductive sticker, clip, etc.

In some non-limiting examples, the “extra-oral electrode” is provided as a so-called electrode patch, for example, similar to EKG, EKG, ECG, EMG, and TENS patches, for example, available from Vermed, Inc. (Below Falls, Vt., USA).

Although not a limitation, the present inventors have determined that in some embodiments, it is advantageous to use a “high frequency” measuring signal, for example, having a frequency of at least 50 KHz when using an “extra-oral electrode” instead of a lip electrode.

In some embodiments, any combination of any one or more features described in WO2007/057878 are used. It is noted that (i) the entirety of WO2007/057878 is incorporated by reference is if set forth; (ii) citation of a reference (for example, WO2007/057878) does not constitute an admission that the reference is prior art. Thus, in some embodiments, a “higher” frequency measuring signal (for example, at least 50 KHZ, for example, between 50 KHZ and 300 KHZ or between 50 KHZ and 250 KHZ or between 50 KHZ and 200 KHZ) is provided between the “root canal” electrode and the “extra-oral electrode.”

It is now disclosed for the first time an apparatus for effecting dental measurements. The apparatus comprises: a) a root canal electrode (for example, a dental file) insertable into the root canal of a tooth of a patient; b) a control unit including: i) a housing; ii) a current generator having a first terminal and a second terminal, the current generator being operative to produce a time varying current having a frequency of at least about 50 KHz and/or at most about 300 KHz between the first and second terminals, the current generator being deployed within the housing of the control unit; and iii) a detection element configured to sense an impedance-related parameter between the first and second terminals of the current generator, the detection element being deployed within the housing of the control unit; and c) an electrode patch detachably attached to the control unit, the electrode patch having a body-contactable surface that: i) is skin adhesive and ii) includes an electrically conductive region, the electrically-conductive region being in electrical contact with the first terminal of the current generator; and d) a wire (for example, an insulated wire of at least a few centimes) connecting the root canal electrode to the control unit such that the root canal electrode is in electrical contact with the second terminal of the current generator.

In some embodiments, the electrode patch is flexible.

In some embodiments, a ratio between a length of the connecting wire and a distance between the electrically conductive region of the attached electrode patch and the first terminal of the current generator is at least 10:1 (or at least 15:1 or at least 20:1).

In some embodiments, a ratio between a length of the connecting wire and characteristic length of the housing is at least 10:1 (or at least 15:1 or at least 20:1).

In some embodiments, the body-contactable surface is coated with an adhesive substance to provide the skin adhesive property.

In some embodiments, the apparatus further includes e) a conductive fastener which fastens the housing to the electrode patch and provides electrical contact between the first terminal and the electrode patch.

In some embodiments, the conducting fastener is mechanically integrated with the housing.

In some embodiments, the housing includes an electrically-conducting female snap receptacle for receiving a male snap of the electrode patch.

In some embodiments, the apparatus further comprises: e) a processing element for deriving from the sensed impedance-related parameter a multiple of a distance between a fixed point on the root canal electrode 4 and the apical position of the tooth; and f) at least one data presentation element selected from the group consisting of a display monitor and a speaker for presenting, to a user, the multiple of the distance.

In some embodiments, the at least one data presentation element is mechanically integrated with the housing of the control unit.

In some embodiments, the apparatus further comprises: e) a wireless data transmitter for wirelessly transmitting data representative of the impedance-related parameter.

In some embodiments, the apparatus further comprises: e) a processing element for deriving from the sensed impedance-related parameter a multiple of a distance between a fixed point on the root canal electrode and the apical position of the tooth; and

f) a wireless data transmitter for wirelessly transmitting data representative of the multiple of the distance.

It is now disclosed for the first time an apparatus for effecting dental measurements, the apparatus comprising: a) a root canal electrode (for example, a dental file) insertable into the root canal of a tooth of a patient; b) a control unit including: i) a housing; ii) a current generator having a first terminal and a second terminal, the current generator being operative to produce a time varying current having a frequency of at least about 50 KHz and/or at most about 300 KHz between the first and second terminals, the current generator being deployed within the housing of the control unit; and iii) a detection element configured to sense an impedance-related parameter between the first and second terminals of the current generator, the detection element being deployed within the housing of the control unit; and c) at least one of: i) an electrically conductive fastener that is mechanically integrated with the housing and in electrical contact with the first terminal of the current generator; ii) an electrically conductive female snap receptacle that is mechanically integrated with the housing and in electrical contact with the first terminal of the current generator and iii) a bracelet sized and dimensioned for a human wrist, the bracelet being mechanically integrated with the housing and including an electrically conductive portion that is in electrical contact with the first terminal of the current generator.

It is now disclosed for the first time a method of effecting dental measurements for a patient, the method comprising: a) providing a control unit including i) a housing; ii) a current generator deployed within or on the housing of the control unit; and iii) a detection element deployed within or on the housing b) attaching the housing to a patient's arm such that the human arm is in electrical contact with the current generator via an electrically conductive element on the surface of the skin of the patient's arm; c) inserting a root canal electrode that is in electrical contact with the current generator into a root canal of a tooth of the patient; d) using the current generator, generating a time varying current having a frequency of at least about 50 KHz and/or at most about 300 KHz between the root canal electrode and the electrically conductive element on the surface of the skin of the patient's arm; e) at a time that the time varying current flows between the root canal electrode and the electrically conductive element on the surface of the skin of the patient's arm, measuring an impedance-related parameter between the root canal electrode and the electrically conductive element on the surface of the skin of the patient's arm.

In some embodiments, the method further comprises: f) deriving from the impedance-related parameter a multiple of a distance between a fixed point on the root canal electrode and the apical position of the tooth; g) effecting at least one of: i) displaying an indication of the multiple of the distance; and ii) wirelessly transmitting data representative of the multiple of the distance.

In some embodiments, the attaching of the patient's arm to the human arm includes attaching the housing to the wrist of the patient's arm.

It is now disclosed for the first time a method of effecting dental measurements for a patient, the method comprising: a) attaching a body electrode to an arm of the patient; b) inserting a root canal electrode into a root canal of a tooth; c) generating a time varying current between the root canal electrode and the body electrode that is at least about 50 KHz and/or at most about 300 KHz; and d) at a time that the time varying current flows between the root canal electrode and the patient's arm, measuring an impedance-related parameter between the root canal electrode and the body electrode, and e) deriving from the impedance-related parameter a multiple of a distance between a fixed point on the root canal electrode and the apical position of the tooth.

In some embodiments, the attaching of the patient's arm to the human arm includes attaching the housing to the wrist of the patient's arm.

### BRIEF DESCRIPTION OF THE DRAWINGS

FIG. 1A, 2 illustrates an apex locator including an adhesive extra-oral electrode in contact with skin of the patient's lower arm.

FIG. 1B, 4, 5 are diagrams of an apex locator.

FIGS. 3A-3D illustrate a control unit attached to an electrode patch in contact with the patient's skin.

FIG. 6 is a circuit diagram for a theoretical discussion.

### DETAILED DESCRIPTION OF EMBODIMENTS

The present invention will now be described in terms of specific, example embodiments. It is to be understood that the invention is not limited to the example embodiments disclosed. It should also be understood that not every feature of the systems for providing storage for a host device and methods of securing data described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

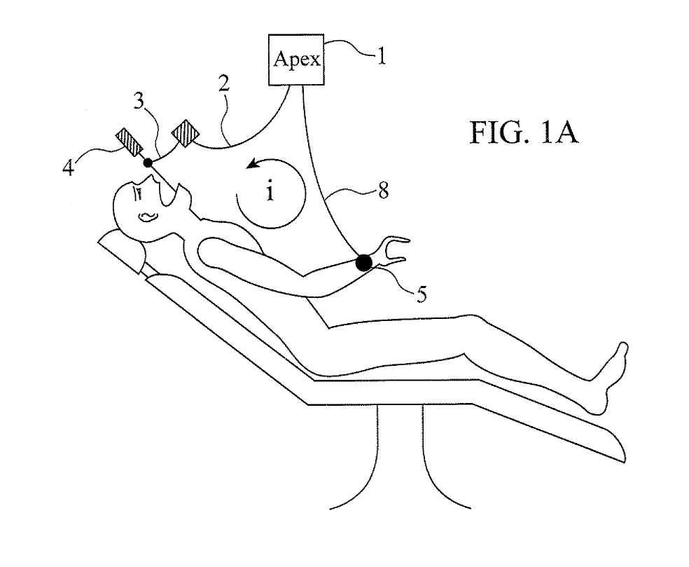

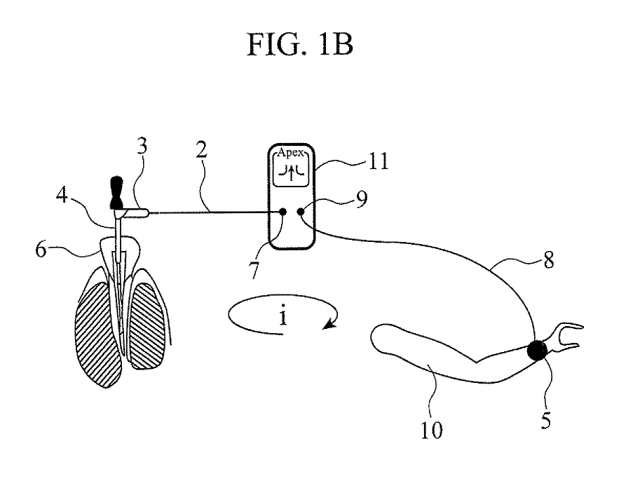

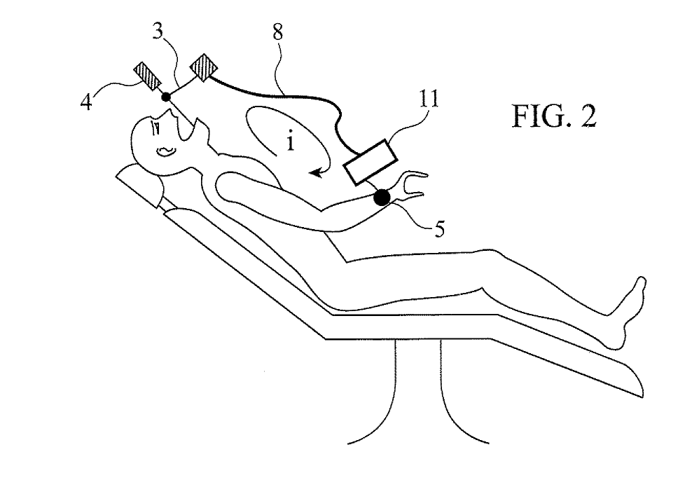

Reference is made of FIGS. 1A-1B.

FIGS. 1A,1B show an example of an apex locator using a file clip 3 together with the electrically-conductive dental file 4 (which serves as a first “root canal” measuring electrode) and a conductive sticker 5 serving as a second measuring “extra-oral” electrode attached to the patient's arm 10. Both electrodes are wired to the apex locator 1 input ports (7,9). The apex locator 1, operative to (i) measure an impedance between the first root canal measuring electrode and the second extra-dental file electrode 10 and to (ii) determine from the measured impedance a distance between a bottom of dental file (4) and the apical constriction of the tooth, applies a high frequency voltage and/or a regulated current (for example, alternating current regulated to have a substantially constant amplitude—see, for example WO2007/057878) via the electrodes into the patient's body. In the body the current is forced to flow (for example, as shown in FIG. 1) through the treated root canal due to electrical contact between the file clip 3 and the file 4 inserted into the root canal.

In the example of FIGS. 1A-1B, we note that “Apex Locator” includes: (i) a current generator for generating the time varying current; (ii) a detection element (for example, a voltmeter) for detecting an impedance-related parameter (for example, a voltage difference) between the first “root canal” electrode and the second; and (iii) a processing element for deriving, from the impedance-related parameter (for example, from the voltage difference) a multiple of a distance between a fixed point on the root canal electrode and the apical position of the tool.

In the example of FIG. 2, the current generator, detection element and optionally the processing element are provided within housing of a control unit 11 deployed on the lower arm (for example, on the wrist) of the patient. This obviates the need to have multiple wires and a “separate” apex unit which must be maintained.

The system of FIG. 2 includes only a “single measuring wire” (i.e. insulated wire of at least 10 centimeters) 8, in contrast with the system of FIGS. 1A-1B which includes two such wires (2,8). In some embodiments, an advantage of such embodiment is the use of a “single measuring wire.” One or more additional features provided by the system of FIG. 2 are:

1) Convenience to the patient and dentist by avoiding the use of a lip electrode;

2) Achieving a reliable electrical contact (proven during clinical tests);

3) Avoiding the need of sterilization of the electrode (Lip hook needs sterilization while the disposable patch does not require a sterilization procedure after use).

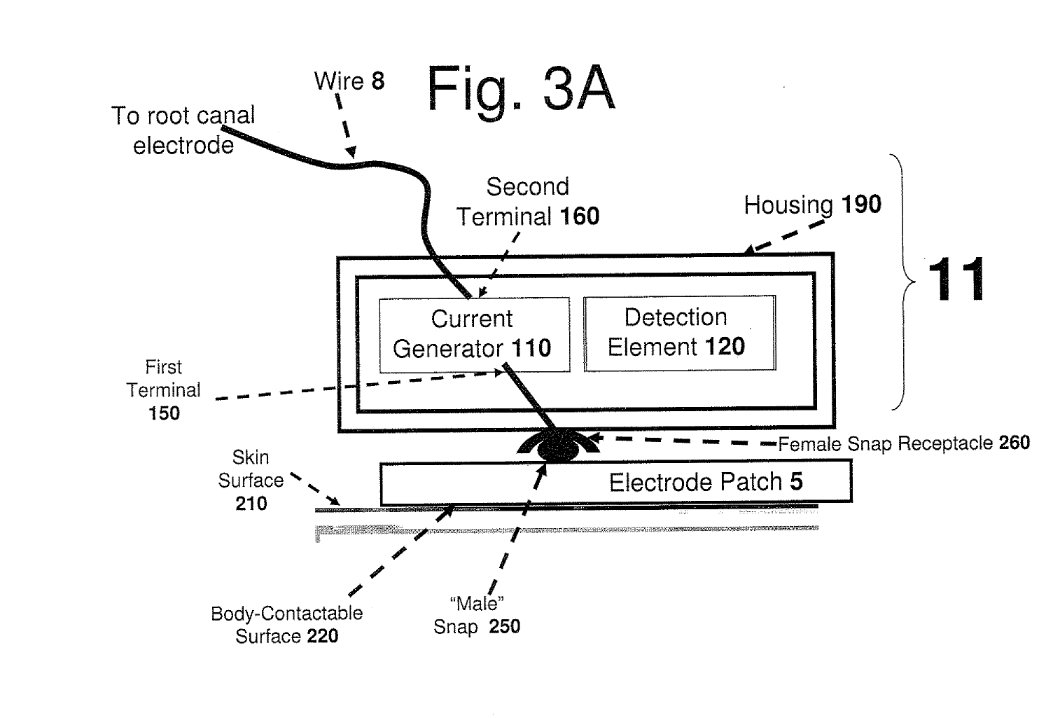

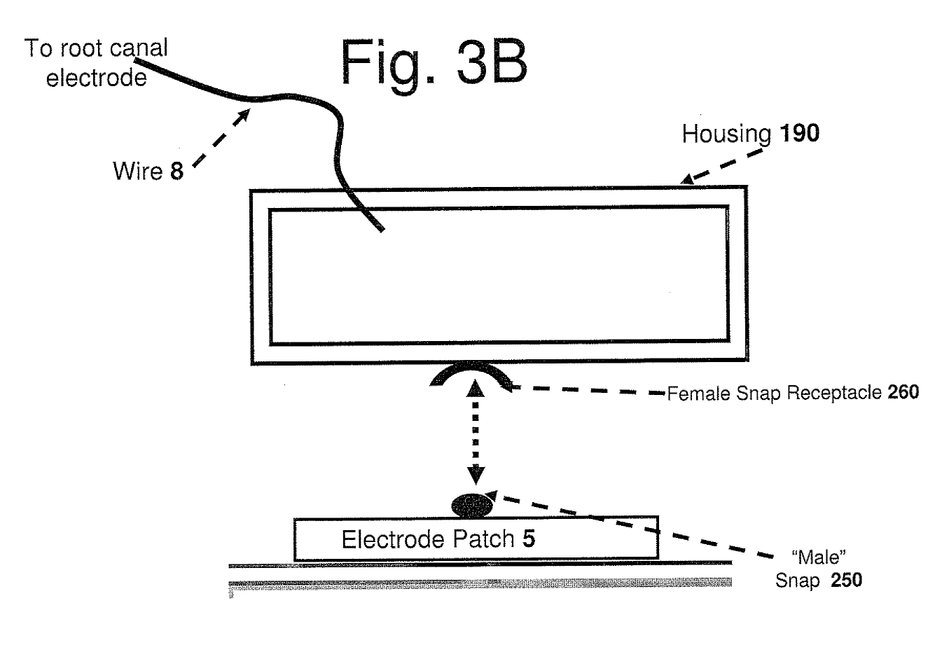

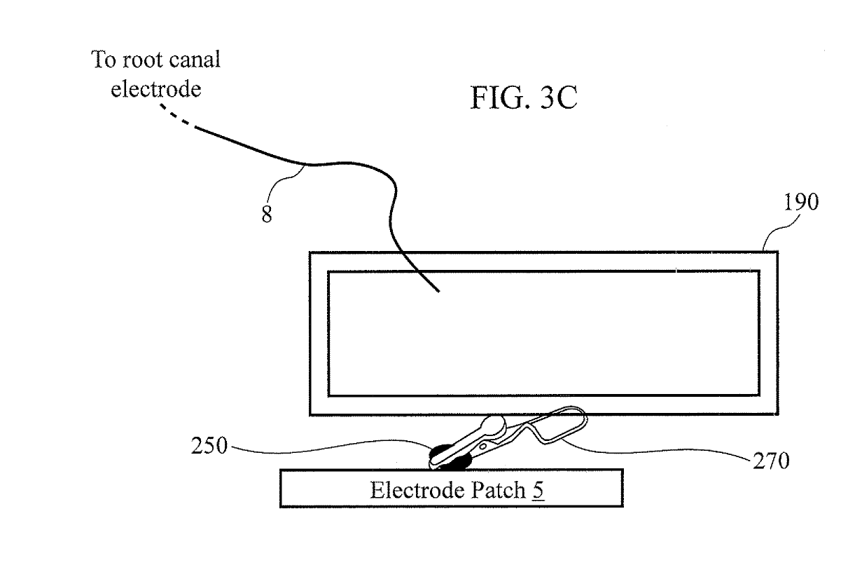

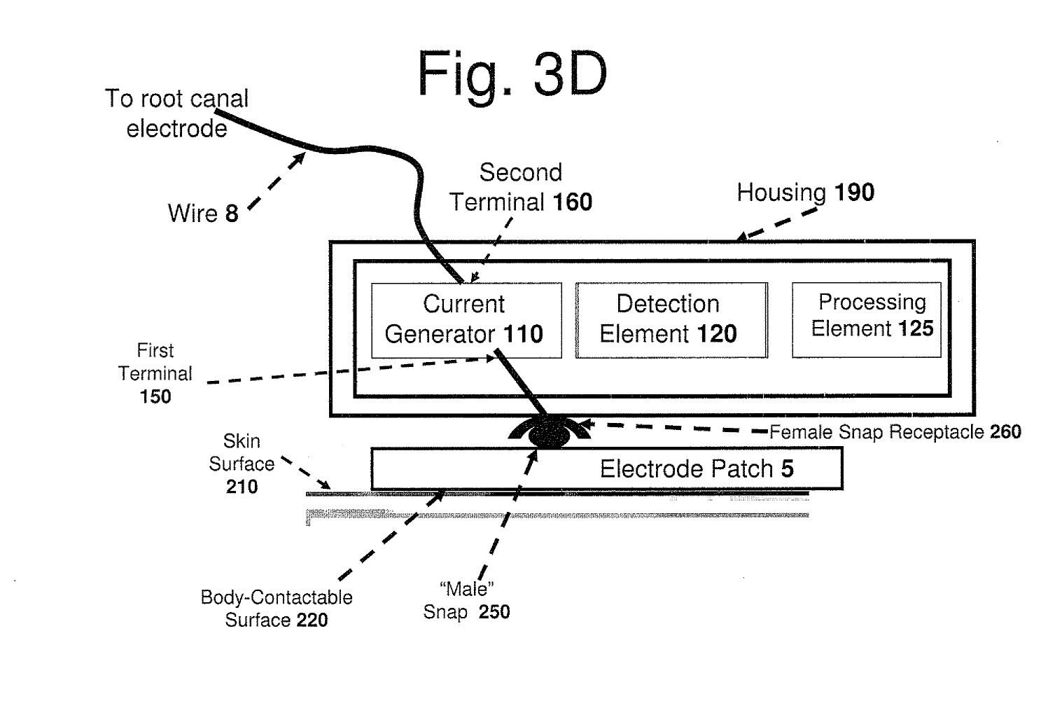

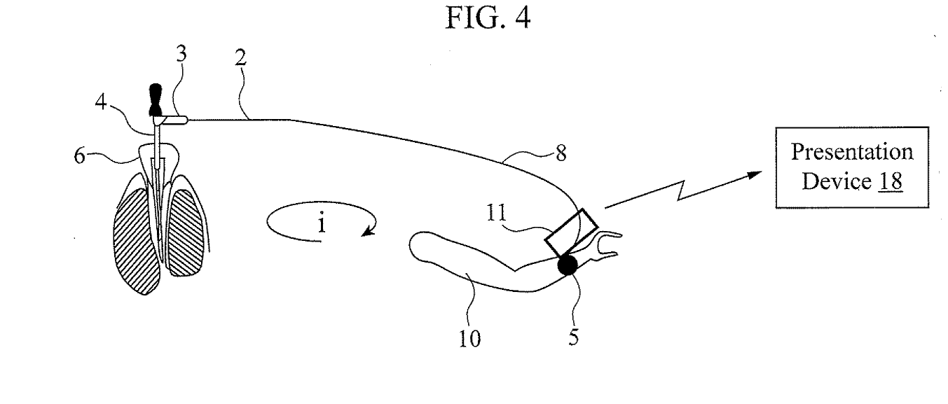

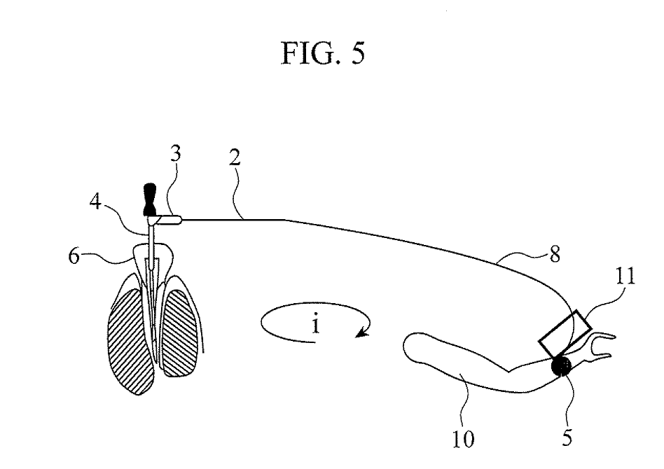

FIG. 3A illustrates an exemplary control unit 11 mechanically attached to an electrode patch 5 (for example, an EKG patch or any other appropriate patch) that includes an adhesive body-contactable surface 220 in contact with skin surface 210. Because body-contactable surface 220 of patch 5 includes an electrically-conductive region which is in electrical contact with current generator 110, electrode patch 5 serves as the “extra-oral electrode” and is part of an electrical circuit that includes current generator 110 (for example, an AC power supply), insulated wire 8 and root canal electrode 4 (which in this case happens to be a dental file).

Control unit 11 includes a housing 190, and a current generator 110 and detection element 120 deployed within the housing 190. Current generator 190 produces a time varying current. In some embodiments, this is a regulated current having substantially a constant amplitude where the amplitude is substantially independent of the distance between a fixed point of root canal electrode 4 and the apical position of the tooth 6 into which root canal electrode is inserted. In some embodiments, the time varying current is a relatively “high-frequency” current having a frequency of at least 50 KHz.

It is noted that the voltage difference between first terminal 150 and second terminal 160 is typically much greater than either: (i) the voltage difference between first terminal 150 and skin surface 210 which his in contact with body-contactable surface 220 of electrode patch 5; and (ii) the voltage difference between second electrode 160 and root canal electrode 4. Thus, in order to measure an impedance parameter (for example, a voltage difference) between root canal electrode 4 it is sufficient to measure the impedance parameter between first 150 and second 160 terminals using detection element 120 (for example, a volt-meter).

On salient feature of the system illustrated in FIG. 3A is that the control unit 11 and housing 190 is mechanically attached (i.e. in a reversible manner) to electrode patch 5. Towards this ends, housing 190 includes an electrically conducting female snap receptacle 260 that is mechanically integrated into housing 190, and can connect with the electrically-conducting “male snap” 250 of electrode patch 5.

As illustrated in FIG. 3B, on salient feature provided by this embodiment is that the electrode patch is “detachably attachable” (i.e. may be easily detached without damaging control unit 190 or electrode patch 5) to electrode patch 5. Thus, electrode patch provides a relatively-inexpensive disposable electrode for completing the surface with a body surface of the patient—in addition, there is no requirement to specifically sterilize electrode patch 5.

FIG. 3C illustrates an embodiment wherein housing 190 is mechanically fastened to electrode patch 5 using a conducting fastening element (for example, alligator clip 270).

In the embodiment of FIG. 3D, a signal processing element 125 is also included within housing 190. Processing element 125 is operative to derive from the sensed impedance-related parameter a multiple of a distance between a fixed point on the root canal electrode and the apical position of the tooth. Processing element 125 may include any combination of electrical circuitry and/or executable code modules stored on a computer medium.

In the embodiment of FIG. 3D, processing element 125 is deployed within housing 190. Alternatively, processing element 125 may be deployed outside of housing 190—for example, “remotely.”

In the embodiment of FIG. 4, control unit 11 includes a wireless data transmitter (not numbered in the figure) for transmitting (i) data representative of the impedance-related parameter as determined by detection element 120 and/or (ii) data representative of the multiple of a distance between a fixed point on the root canal electrode 4 and the apical position of the tooth as determined by processing element 125.

The transmitted data may be received by presentation device 18 for example, a video display screen and/or a speaker for “presenting” the data in an audio manner. In one embodiment, presentation device 18 is operatively coupled to a “wireless receiver.” In one specific embodiment, presentation device 18 is part of a laptop or desktop computer.

In one example, processing element 125 is part of control unit 11 as illustrated in FIG. 3D. Alternatively, processing element 125 may be associated with to presentation device 18. In one particular example, presentation device 18 is a digital computer with a display screen and/or speaker and processing element 125 is the combination of software stored on a computer-readable medium (for example, a hard-drive or flash memory of the digital computer).

In contrast to the system of FIG. 1B where a plurality of “long insulated wires” (2 and 8) having a length of at least 10 cm is required, in the system of FIG. 5 only a single such “long insulated wire” 8 is required.

### Kit

Although the system of FIG. 2 is shown “assembled” where the patch 5 is mechanically engaged to the housing 190 of the control unit 11, it is contemplated that in some embodiments a “kit” may be provided including the control unit 11, the insulated wire 8, one or more patches 5 (for example, a hunch of “sample patches”), and possibly root canal electrode 4.

### Bracelet Discussion

Although certain embodiments related to an electrode patch are discussed, this is not a requirement. Alternatively, housing 190 may be mechanically fastened to a bracelet (not shown) around the patient's wrist (i) which includes an electrically conductive portion in contact with the patient's skin at the wrist or lower arm; and where (ii) the electrically conductive portion is in electrical contact with first terminal 150 of control unit 11.

Thus, in some embodiments, the bracelet is sized and dimensioned for a human wrist (i.e. can be worn on a human wrist), and the bracelet is mechanically integrated with the housing 190 of control unit 11 and the bracelets includes an electrically conductive portion that (i) contacts the skin 210 of the lower arm/write and is in electrical contact with the first terminal 150 of the current generator 110.

### Theoretical Discussion

The present section is illustrative only—there is no desire to be bound by any theory.

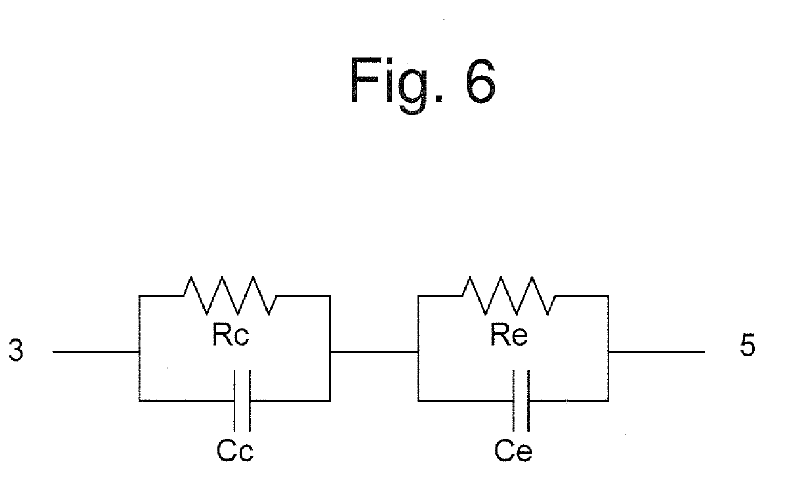

Reference is made to FIG. 6.

The electric equivalent circuit of the measured path between both (i) the root-canal measuring electrodes (i.e. in this case including 3 and 4) and (ii) the extra-oral electrode 5 can be described by two sets of one resistor parallel to one capacitor; both sets connected in series. One of the sets Cc and Rc represent the equivalent impedance between the file and the gums/oral tissue. The second set Ce and Re represents the impedance between the oral area and the external electrode 5.

It is known that the values of the resistances and capacitances in the body are nonlinear and highly frequency dependent. In modern electronic apex locators the value of Cc is the one of interest. However, in the proposed configuration Ce may dominate the equivalent capacitance in the circuit and, furthermore, in the multi frequency algorithms, the frequency dependent variations of the circuit components Rc, Cc, Re, Ce is not proportional. Therefore, those algorithms are of no use.

The higher the frequency becomes, the capacitance Cc starts to dominate the circuit. At frequencies of about 50 KHz and higher, the impact of Ce//Re can be neglected. Therefore the single high frequency model of APX21 will operate perfectly with exactly the same calibration value as when used with a lip hook.

The described performance was clinically verified with the APX21, and on the contrary, other multi-frequency apex locators like Root-ZX, Propex, Medic NRG and iPex didn't perform at all in the new configuration.

### Additional Discussion

Experiments performed by the present inventors have shown that use of a regulated current source (e.g. a regulated alternating current source), and in particular, a current source having a substantially constant amplitude, is useful for producing stable measurements of the position of the root canal or dental file electrode within the root canal.

Not wishing to be bound by any particular theory, it is believed that use of a constant voltage source with un-regulated fluctuating current (e.g. current whose amplitude fluctuates as the root canal electrode is inserted deeper into the root canal, or raised in the canal) may influence the electrical properties of the biological tissue associated with the root canal and the apex (for example, tissue in the canal and/or below the apex). Because the determined apical position depends on the measured electrical properties of the biological tissue, it is believed that use of a constant voltage source with un-regulated fluctuating current can therefore, in certain situations, introduce instabilities and inaccuracies in the assessed distance between the root canal electrode 4 and the apex (or apical constriction) of the tooth. Once more, not wishing to be bound by any particular theory, it is thus believed that, in contrast, regulated current sources, and in particular a current sources having a substantially constant amplitude, are useful for reducing these inaccuracies and instabilities certain clinically relevant situations.

As used herein, production of “a regulated current” entails producing a current with a predefined current profile. Examples of producing a “regulated current” include producing a constant amplitude current and a substantially constant amplitude current.

The terms “apical section” or “apical region” relate to the region between the apical constriction (minor foramen) (or points less than 0.2 mm above the apical constriction) and the apex (major foramen) of the tooth. It is noted the term “apical position” is intended in the broadest sense, and includes any point in the apical region. In some embodiments, the “apical position” is specifically intended to mean the apex (major foramen) of the tooth.

The term “dental neck” region is the region of the root canal above the apical section, e.g. above the apical constriction, or above a point between 0 and 0.2 mm above the apical constriction.

According to some embodiments, a “regulated current source 110 having a substantially constant current amplitude” supplies, between the root canal electrode 4 and the skin of the patient outside of the patient's mouth (for example, the skin of the lower arm) (and also between first 150 and second 160 terminals), current whose amplitude is constant within a tolerance of no more than 10%. According to some embodiments, the amplitude is constant within a tolerance of no more than 5%. According to some embodiments, the amplitude is constant within a tolerance of no more than 1%.

As used herein, an “impedance related parameter” is a parameter that is a known function of an impedance. One example of an “impedance related parameter” is an impedance.

There is no limitation on the amplitude or amount of current which flows between the root canal electrode 4 and electrode patch 5 (or the wrist bracelet) and/or the patient's skin in contact with an ‘extra-oral electrode). In exemplary embodiments, between 1 microampere and 120 microamperes flow between the two electrodes. In some embodiments, between 5 microampere and 55 microamperes flow between the two electrodes. In one particular example, between 8 and 12 microampere flow between the two electrodes.

It is noted that constant amplitude current sources 10 are well known in the art, and are either available off the shelf, or can be configured in any number of ways. FIG. 1B provides an exemplary configuration where the amplitude of a constant voltage source is adjusted in accordance with a reading from an internal voltmeter on the circuit such that the current i remains substantially constant. Nevertheless, it is stressed that this is merely an illustrative example and is not intended as limiting. Any constant amplitude current source using any mechanism for maintaining a substantially amplitude current is within the scope of the present invention.

According to some embodiments, in one example, measurement output (e.g. output from a detection element 120 which is, for example, a voltmeter) of an impedance parameter (e.g. a parameter that is a function of the impedance at a given frequency) between the root canal electrode 4 and the electrode in contact with the skin of the patient (for example, electrode patch) is determined. The measured impedance parameter (for example, derived by using the detection element 120 to measure an instantaneous voltage amplitude between the root canal electrode 4 and the electrode patch 5 or bracelet) is correlated with the depth of the root canal electrode tip in the root canal, allowing the arrival of the tip at the root apex to be detected. Thus, in some embodiments, the device includes a processing unit 125 which is operative to output a distance (or a multiple of a distance) between a fixed point of the root canal electrode 4 (e.g. the tip of the electrode) and a fixed point in the apical section (e.g. the root apex, the location of the apical constriction, or any other fixed point) (see FIG. 1B). In one example, the processing unit includes a look up table correlating the instantaneous voltage amplitude measured by detection element 120), with the distance between a fixed point of the root canal electrode 4 (e.g. the tip of the electrode) and a fixed point in the apical section.

It is noted that optionally, a portion of the root canal, or the entirety of the root canal is filled with a liquid (e.g. saline, blood) and/or tissue (e.g. blood vessels, nerves, pulp) while the electrode 4 is inserted into the root canal.

In some embodiments, the root canal electrode or probe 4 is a dental file or reamer inserted into the root canal. Nevertheless, this is not a limitation of the present invention, and any electrode or probe appropriately dimensioned for insertion into the root canal 2 is appropriate for the present invention.

The terms “dental file” and “reamers” relate to tools used for root canal treatment.

The present inventors have noted that the resistive component of impedance is useful for determining the distance between a fixed point on the root canal electrode 4 and a fixed point in the apex region when the tip of the root canal electrode is located in the dental neck region. Furthermore, the capacitive component of impedance is useful when the tip of the root canal electrode is located in the apical region.

In general, the relative weight of the resistive and capacitive components of impedance is determined, in part, by the values of the resistance and capacitance between the two electrodes. Furthermore, the relative weight of the resistive and capacitive components of impedance is also at least partially determined by the frequency of the measurement signals generated by the power source of current generator 110. Thus, certain embodiments of the present invention are motivated by the observation of the present inventors that a judicious choice of the measurement signal frequency (e.g. selection of a medium frequency) allows one to determine a distance between the fixed point on the root canal electrode and the fixed point in the apex region (e.g. apical constriction, or tooth apex) by determining the value of a capacitance-governed function when the root canal electrode is in the apical region. Furthermore, this same medium frequency also allows one determine a distance between the fixed point on the root canal electrode and the fixed point in the apex region (e.g. apical constriction, or tooth apex) by determining the value of a function at least partially governed by resistance when the root canal electrode is in the dental neck region. In some embodiments, “medium” frequencies, are between 50 KHZ and 300 KHZ. In some embodiments, “medium” frequencies, are between 50 KHZ and 200 KHZ. In some embodiments, “medium” frequencies, are between 50 KHZ and 250 KHZ.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1) An apparatus for effecting dental measurements, the apparatus comprising:
a) a root canal electrode insertable into the root canal of a tooth of a patient;
b) a control unit including:
i) a housing;
ii) a current generator having a first terminal and a second terminal, the current generator being operative to produce a time varying current having a frequency of at least about so KHz and at most about 300 KHz between the first and second terminals, the current generator being deployed within the housing of the control unit; and
iii) a detection element configured to sense an impedance-related parameter between the first and second terminals of the current generator, the detection element being deployed within the housing of the control unit; and
c) an electrode patch detachably attached to the control unit, the electrode patch having a body-contactable surface that:
i) is skin adhesive and
ii) includes an electrically conductive region, the electrically-conductive region being in electrical contact with the first terminal of the current generator; and
d) a wire connecting the root canal electrode to the control unit such that the root canal electrode is in electrical contact with the second terminal of the current generator.

2) The apparatus of claim 1 wherein the electrode patch is flexible.

3) The apparatus of claim 1 wherein a ratio between a length of the connecting wire and a distance between the electrically conductive region of the attached electrode patch and the first terminal of the current generator is at least 10:1.

4) The apparatus of claim 1 wherein a ratio between a length of the connecting wire and characteristic length of the housing is at least 10:1.

5) The apparatus of claim 1 wherein the body-contactable surface is coated with an adhesive substance to provide the skin adhesive property.

6) The apparatus of claim 1 further comprising:
e) a conductive fastener which fastens the housing to the electrode patch and provides electrical contact between the first terminal and the electrode patch.

7) The apparatus of claim 6 wherein the conducting fastener is mechanically integrated with the housing.

8) The apparatus of claim 1 wherein the housing includes an electrically-conducting female snap receptacle for receiving a male snap of the electrode patch.

9) The apparatus of claim 1 further comprising:
e) a processing element for deriving from the sensed impedance-related parameter a multiple of a distance between a fixed point on the root canal electrode and the apical position of the tooth; and
f) at least one data presentation element selected from the group consisting of a display monitor and a speaker for presenting, to a user, the multiple of the distance.

10) The apparatus of claim 9 wherein the at least one data presentation element is mechanically integrated with the housing of the control unit.

11) The apparatus of claim 1 further comprising:
e) a wireless data transmitter for wirelessly transmitting data representative of the impedance-related parameter.

12) The apparatus of claim 1 further comprising:
e) a processing element for deriving from the sensed impedance-related parameter a multiple of a distance between a fixed point on the root canal electrode and the apical position of the tooth; and
f) a wireless data transmitter for wirelessly transmitting data representative of the multiple of the distance.

13) An apparatus for effecting dental measurements, the apparatus comprising:
a) a root canal electrode insertable into the root canal of a tooth of a patient;
b) a control unit including:
i) a housing;
ii) a current generator having a first terminal and a second terminal, the current generator being operative to produce a time varying current having a frequency of at least about 50 KHz and at most about 300 KHz between the first and second terminals, the current generator being deployed within the housing of the control unit; and
iii) a detection element configured to sense an impedance-related parameter between the first and second terminals of the current generator, the detection element being deployed within the housing of the control unit; and
c) at least one of:
i) an electrically conductive fastener that is mechanically integrated with the housing and in electrical contact with the first terminal of the current generator;
ii) an electrically conductive female snap receptacle that is mechanically integrated with the housing and in electrical contact with the first terminal of the current generator and
iii) a bracelet sized and dimensioned for a human wrist, the bracelet being mechanically integrated with the housing and including an electrically conductive portion that is in electrical contact with the first terminal of the current generator.

14) A method of effecting dental measurements for a patient, the method comprising:
a) providing a control unit including
i) a housing;
ii) a current generator deployed within or on the housing of the control unit; and
iii) a detection element deployed within or on the housing
b) attaching the housing to a patient's arm such that the human arm is in electrical contact with the current generator via an electrically conductive element on the surface of the skin of the patient's arm;
c) inserting a root canal electrode that is in electrical contact with the current generator into a root canal of a tooth of the patient;
d) using the current generator, generating a time varying current having a frequency of at least about 50 KHz and at most about 300 KHz between the root canal electrode and the electrically conductive element on the surface of the skin of the patient's arm;
e) at a time that the time varying current flows between the root canal electrode and the electrically conductive element on the surface of the skin of the patient's arm, measuring an impedance-related parameter between the root canal electrode and the electrically conductive element on the surface of the skin of the patient's arm.

15) The method of claim 14 further comprising:
f) deriving from the impedance-related parameter a multiple of a distance between a fixed point on the root canal electrode and the apical position of the tooth;
g) effecting at least one of:
i) displaying an indication of the multiple of the distance; and
ii) wirelessly transmitting data representative of the multiple of the distance.

16) The method of claim 14 wherein the attaching of the patient's arm to the human arm includes attaching the housing to the wrist of the patient's arm.
